(19) United States
(12) Patent Application Publication
(10) Pub. No.: US 2026/0213921 A1
(43) Pub. Date: Jul. 23, 2026

(54) Technology for Sharing a Digital Key for a Motor Vehicle

(71) Applicant: Bayerische Motoren Werke Aktiengesellschaft, Muenchen (DE)

(72) Inventor: Matthias FINK, Muenchen (DE)

(21) Appl. No.: 19/451,088

(22) Filed: Jan. 16, 2026

(30) Foreign Application Priority Data
Jan. 17, 2025 (DE) 10-2025101720.4

(51) Int. Cl. H04L 9/08; B60R 25/24; G07C 9/00; H04L 9/32

(52) U.S. Cl. CPC H04L 9/0819; B60R 25/241; G07C 9/00309; G07C 9/00896; H04L 9/3263; H04L 2209/84

(57) ABSTRACT

A system permits sharing a digital key for a motor vehicle. A key-sharing point provide a first sharing identifier based on a received specification relating to a receiver of the digital key, and sends the first sharing identifier to a vehicle-side backend server for verification of the sharing of the digital key. A receiver device generates a certificate relating to the digital key, which certificate contains a second sharing identifier calculated based on received information relating to the motor vehicle. A device-side backend server calculates the first sharing identifier based on an account assigned to the receiver, which account is determined based on the specification received from the key-sharing point, and sends the first sharing identifier to the key-sharing point. The vehicle-side backend server verifies the key sharing based on the stored first sharing identifier, which is stored in assignment to the digital key.

### CROSS REFERENCE TO RELATED APPLICATION

This application claims priority under 35 U.S.C. §119 from German Patent Application No. DE 10 2025 101 720.4, filed January 17, 2025, the entire disclosure of which is herein expressly incorporated by reference.

### BACKGROUND AND SUMMARY

The invention relates to a technology for sharing a digital key, in particular a digital key for a motor vehicle. The invention can be implemented in a key-sharing point (for example, a terminal or server), a receiver device, a device-side backend, and a vehicle-side backend.

It is known that a digital key (such as a vehicle key) can be stored on a terminal, for example a smart phone, for example in a secure memory of the device. A use of the key is based on interfaces between the secure memory and an operating system of the device, and on interfaces between the operating system and other apps or applications which are executed on the device.

Thus, the “Car Connectivity Consortium” (CCC) defines, by way of the “Digital Key Release 3” in the form of a technical specification, a standard for a digital vehicle key. Corresponding digital keys are finding broader and broader use in an expanded vehicle environment.

Thus, for example, in this framework an application or app of a vehicle producer can be installed on a terminal, which, by means of the digital vehicle key stored on the device, enables an access to the vehicle, enables a control of specific vehicle functions, etc. Expanded usage possibilities additionally result from the presence of a backend system for key management, i.e. a management of the digital vehicle key.

A digital key or vehicle key can be created, for example, by coupling a terminal with a vehicle. In a CCC context, this is called owner coupling (“owner pairing”). The condition is that evidence of ownership has to be presented to the vehicle, for example by a parallel presentation of two key fobs.

A digital key can additionally be forwarded or shared by one device to another (“key sharing”), for example from one user to another user (for example, in a private application), or from a backend to a device or a user (such a server to user application can relate to a commercial service). In such key sharing, the terminal or the terminals, servers of a device-side backend and of a vehicle-side backend, and possibly a server of a service provider for server-based key sharing are involved.

To establish trust in digital keys, the use thereof has to be secure. Therefore, according to the CCC, current cryptographic methods are applied. Nonetheless, the procedure of key sharing has weak points. For example, key sharing is based on sending a URL (“Uniform Resource Locator”). The URL is then to be retrieved on the device on which the shared key is to be saved (the retrieval triggers the actual key sharing, which results in the generation of the digital key). However, the URL is generic, i.e. it can be retrieved on and by any arbitrary device on which a digital key can be saved. The sender of the URL has no options for specifying restrictions, i.e. for example preventing forwarding of the URL.

For this reason, additional mechanisms have to be provided, which complicates the entire procedure. For example, a second factor can be provided (“two-factor authentication”, 2FA, or multifactor authentication, MFA). The second factor can be, for example, a key fob, a further digital key (having a scope of authorization which also comprises the shared key), and/or a PIN (“personal identification number”). A presentation, input, etc. of the second factor is necessary to activate the shared key (a nonactivated key does not permit starting or driving of the vehicle, but can enable an access to the vehicle, for example so that a PIN can be input at a console in the vehicle).

As stated, key sharing with 2FA is complicated for the user. In this case, the second factor also cannot fully ensure that only the intended or authorized user installs the shared key on his terminal: The intended user cannot only forward the sharing URL in an unauthorized manner, but also pass on a key fob or a PIN.

If a key is passed on between natural persons, a trust relationship can be presumed between these persons or parties, so that unauthorized forwarding of the sharing URL generally does not take place and technical measures to prevent this are not urgent. However, at latest when server-based key sharing to a customer, a service provider, an employee of a company, etc. is to take place, technical measures are necessary to design key sharing to be trustworthy and with minimal complexity so that a key can only be installed on the terminal of the person intended for it.

One object underlying the present invention is to provide an improved concept for a technology for sharing a digital key. The invention achieves this object by means of the subjects of the independent claims. Dependent claims reflect preferred embodiments.

At least one embodiment relates to a method for sharing a digital key. The method can be implemented in or by a key-sharing point (or entity, instance, etc.), thus, for example, a terminal of a sharing person or a sharing user, or a server, for example, of a service provider. The method comprises receiving a specification relating to a receiver of the digital key; based on the received specification, providing a first sharing identifier; and sending the first sharing identifier to a vehicle-side backend for a verification of the key sharing.

In some embodiments, the receiving comprises accepting an input at a terminal of the user. The specification can be received at a server for key sharing.

In some embodiments, providing the first sharing identifier comprises sending the specification to a first backend of a terminal of the intended receiver (receiver device). In some of these embodiments, the sending takes place via a second backend for the terminal of the sharing user. The first and the second backend can be the same backend, for example, if both terminals (of the sharing and receiving user) use a terminal of the same producer, or these can be different backend systems if the user sharing the key and the user receiving the key use terminals of different producers.

At least one embodiment relates to a method for sharing a digital key. This method can be implemented, for example, in a backend of the terminal which is intended to receive the shared digital key. The method comprises receiving a specification relating to a receiver of the digital key from a key-sharing point; based on the received specification; determining an account assigned to the receiver; based on the determined account, calculating a first sharing identifier; and sending the first sharing identifier to the key-sharing point.

In some embodiments, the specification relating to the receiver comprises at least one of an email address, a telephone number (for example, of a terminal of the receiver), an account name, account identifier, account ID, etc.

In some embodiments, information relating to the motor vehicle is sent or received in association with the specification. This motor vehicle-related information can comprise, for example, an identifier or an ID for a vehicle (i.e. a vehicle ID) and/or an ID for a producer of the motor vehicle. Calculating the first sharing identifier can comprise processing this received information.

At least one embodiment relates to a method for sharing a digital key. The method can be implemented, for example, in a receiver device of the receiver of the digital key to be shared. The method comprises receiving information relating to the motor vehicle; based on the information, calculating a second sharing identifier; and generating a certificate relating to the digital key, wherein the certificate contains the second sharing identifier.

The information can be motor vehicle-related information. The first sharing identifier and the second sharing identifier can be calculated in the same way. The certificate can relate to an endpoint for the digital key which is generated according to the TCC during the key sharing on the receiver device. The certificate can reach a vehicle-side backend in a procedure of key sharing, for example, and verification can take place there based on the second sharing identifier.

At least one embodiment relates to a further method for sharing a digital key. This method can be implemented, for example, in a vehicle-side backend, thus, for example, on a server operated by a producer of the motor vehicle. The method comprises storing a first sharing identifier in assignment to the digital key; and verifying the key sharing based on the stored first sharing identifier

The first sharing identifier can be the first sharing identifier described herein. The key sharing can comprise receiving a second sharing identifier. The second sharing identifier can be the second sharing identifier described herein. The verification comprises comparing the received second sharing identifier and the stored first sharing identifier.

Some embodiments comprise storing (in assignment to the digital key) an indication relating to a backend for a receiver device of the key sharing (thus a producer ID relating to the receiver device). The verification can then also take place based on the stored indication.

In some embodiments, the first and/or the second sharing identifier are anonymized such that no inferences are possible about the key-sharing user, the receiving user or receiver (i.e., for example, about a receiver account), and/or the relevant motor vehicle, its producer, etc.

In some embodiments, the first and/or the second sharing identifier comprises a standardized hash value (standardized, for example, according to TCC). In some embodiments, it can be the account information hash or “AccountInfoHash” according to CCC.

At least one embodiment relates to a terminal designed to carry out a method described herein. The terminal can thus either be a terminal of the key-sharing user or a terminal of the receiver of the key sharing.

At least one embodiment relates to a backend server designed to carry out a corresponding method described herein. The server can be operated by a producer of the motor vehicle or a producer of the terminal of the receiver of the shared key (or the terminal of the sharing user).

At least one embodiment relates to a system which comprises a motor vehicle, for the usage of which a digital vehicle key is present, which is to be shared. The system furthermore comprises a key-sharing point or entity. This point can comprise a terminal of a sharing user, or can comprise a server which is designed for server-based key sharing. The server can be operated by a producer of the vehicle, or can be operated by a service provider who operates their own key management.

The system furthermore comprises a receiver device (i.e. a terminal of a receiver of the shared key); a server of a device-side backend; and a server of a vehicle-side backend, wherein the servers are each designed to carry out corresponding methods as described herein.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a system according to at least one embodiment;

FIG. 2 illustrates the system according to at least one embodiment;

FIG. 3A illustrates a flow chart according to at least one embodiment;

FIG. 3B illustrates a flow chart according to at least one embodiment;

FIG. 3C illustrates a flow chart according to at least one embodiment;

FIG. 3D illustrates a flow chart according to at least one embodiment; and

FIG. 4 illustrates a flow chart according to at least one embodiment.

### DETAILED DESCRIPTION OF THE DRAWINGS

A terminal is to be understood herein as any device at which an electronic communication, a communication network, etc. ends and which is designed for use, operation, etc. by a human user, a person, an operator, a service employee, etc. A terminal can be, for example, a mobile device, a portable device, a wearable, etc., thus, for example, a notebook, tablet, or smart phone, a smart watch, a smart band, a smart ring, etc. Devices for stationary use such as a PC, an operating console, etc. are also considered to be terminals.

When reference is made in short to “a terminal”, constellations are likewise intended to be encompassed in which a terminal having at least one peripheral component is used, thus, for example, a mobile device with a smartcard. A terminal only available in the future can also be meant by “a terminal”, if it has the required processor capacities, storage capacities, etc. for implementing an aspect according to the invention described herein.

A terminal can have a secure memory or secured environment, a secured element, etc., for example based on a corresponding chip, a crypto processor, etc. For example, the secure memory can be an HSM (“Hardware Security Module”), TPM (Trusted Platform Module”), a secured element (“Secure Element”, “Secure Enclave”), a TEE (“Trusted Execution Environment”) etc. A secure memory can be designed for storing or depositing at least one cryptographic, electronic, or digital key. For example, a secure memory can be designed for depositing a cryptographic or digital vehicle key, wherein the latter can be stored, for example, in the form of an endpoint according to CCC.

In server-based key sharing, a key-sharing device in a CCC environment can be designated, for example, as a SBOD (“Server Based Owner Device”) or a SBFD (“Server Based Friend Device”) (both constellations together are referenced as “SBxD”). A SBOD is a root element of a key sharing tree or a key sharing hierarchy, and can be compared with a natural person who has carried out an owner coupling of their terminal with the relevant vehicle. For example, when incorporating a vehicle into a vehicle fleet, a SBOD can be used which can interact with a lender or fleet provider for key sharing.

A SBFD is obtained by direct or indirect key sharing from an owner (a natural person or a backend system). The SBFD can be assigned to a service provider which interacts with the SBFD for key sharing. Customers of the service provider can also be incorporated, for example, in a car sharing service.

A process or procedure of key sharing in which a backend system is involved is designated according to CCC as service activation. A SBxD will normally not exercise its rights (for example, access rights to a vehicle) itself, but rather can forward or pass on these rights to a (granted) shared, forwarded, derived key etc.

As described herein in various ways, a sharing identifier can comprise, for example, a hash. Such a hash or hash value is generally intended to refer to a hash function known per se, in particular to a cryptographic hash function such as a SHA-2 function, thus, for example SHA-224, SHA-256, SHA-384, SHA-512 etc.

When reference is made herein in short to a URL, this is to be understood in general as a sharing reference which can also be, for example, a link, pointer, a URI (“Uniform Resource Indicator”) etc.

A (digital) certificate can in general be part of a PKI (“Public-Key-Infrastructure”). A certificate can be, for example, an intermediate certificate or an end entity certificate. In some embodiments, an intermediate certificate can be a certificate which an instance of a CA (“certificate authority”) has issued, thus an instance CA certificate. Such a CA can be provided, for example, in a secured environment of a terminal.

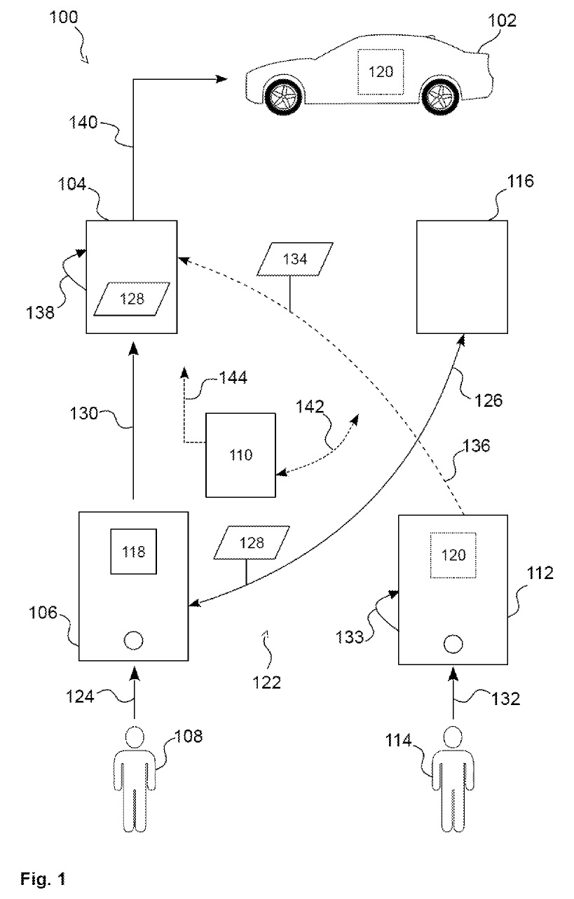

FIG. 1 shows in schematic form a system 100 having a motor vehicle 102, a server 104 of a backend system for the vehicle 102, and a key-sharing point, which either comprises a terminal 106 of a user 108, or alternatively a server 110 designed for server-based key sharing. The system 100 furthermore comprises a terminal or receiver device 112 of a receiver or receiving user 114, and a server 116 in a backend system for the receiver device 112.

A digital vehicle key 118 for the vehicle 102 is stored on the terminal 106. In the case of key sharing, a key 120 is to be derived or shared from the key 118. The shared key 118 is to be deposited on the receiver device 112 (this is indicated by dashed lines).

The reference sign “104” is used hereinafter both to designate in general a or the backend 104 for the vehicle 102, and is also used to specifically designate the server 104 which can be operated, for example, by a producer of the vehicle 102.

In the same way, the reference sign “116” is used hereinafter both in general to designate a or the backend 116 for the receiver device 112, and is also used to specifically designate the server 116. The server 116 can be operated, for example, by a producer of the mobile device 112.

A backend system can also be present for the sharing device 106 (not indicated in FIG. 1). In this case, it can be the backend 116, for example, if both terminals 106 and 112 originate from the same producer. In the exemplary embodiment of FIG. 1, it is presumed that the terminals 106 and 112 originate from different producers, and are supported by different backend systems.

The CCC has not defined a solution for secure key sharing between users of terminals of different producers up to this point. With respect to the example illustrated in FIG. 1, however, there is a need for the granted key 120 only to be able to be deposited on the intended receiver device 112 (in a general case multiple valid receiver devices could also be provided).

According to the invention, it is proposed that key sharing 122 is to take place to a specific predetermined person (in the example of FIG. 1 to user 114). If the key sharing is accepted by a person other than the intended receiver 114, the key sharing procedure is to be aborted without a usable key being deposited on any terminal.

In the example of FIG. 1, the sharing user 108 has to specify or name the intended receiver 114 of the digital key 120 at the beginning of the key sharing procedure 122. Based thereon, the vehicle-side backend 104 checks in the further course of the key sharing procedure 122 whether the actual receiver of the key sharing corresponds with the intended or authorized receiver 114.

Specifically, the sharing user 108 initiates, in a step 124, the key sharing procedure 122 in that a specification relating to the receiver 114 is provided at the sharing terminal 106. The specification can comprise a name of the receiving user 114, for example, a username for a user account of the user 114 (or a part of a username, an abbreviation, etc., wherein the username can be completed, for example, by the device 106). The specification can additionally or alternatively, for example, comprise an email address, telephone number, and/or any other specification which in any way permits a unique identification of the user 114, an account of this user, etc.

In some exemplary embodiments, the user 108 additionally selects a device producer in step 124, i.e. a producer of the receiver device 112. An additional or supplementary security mechanism can be based thereon, by which the receiver device is restricted to a specific (i.e. the predetermined) device producer. If a sharing URL is retrieved on a device or hardware of another device producer, a sharing procedure is aborted.

In a step 126, the sharing terminal 106 requests a (first) sharing identifier 128 from the server 116 of the receiver device 112, which can be, for example, a hash value, preferably a standardized hash value, particularly preferably an account information value according to CCC, which in the exemplary embodiment described here is used according to the invention, converted, or reused for the purposes of the invention. In general, it is to be noted that hash values can be considered to be anonymized (user) IDs, which are provided by a device producer (or multiple producers) to a vehicle producer (or multiple producers). The hash values can be used for grouping or assignment of the created keys per user.

To receive the sharing identifier 128, the sharing terminal 126 can turn directly to the producer backend 116 for the receiver device 112, as indicated for the sake of clarity in FIG. 1. This can be the case, for example, if the terminals 106 and 112 are from the same producer. Alternatively, a backend system of the sharing terminal 106 can request the sharing identifier 128 from the backend 116 for the receiver device 112 (in general only the backend 116 will be able to determine a unique account ID or the like for the user 114).

In a step 130, which is prior to the actual key sharing with creation and sending of a sharing URL, the sharing device 106 gives the received first sharing identifier 128 to the vehicle-side backend 104, where it is stored for the purposes of the later verification.

In a step 132, the receiver 114 retrieves a sharing URL obtained in the sequence of the key sharing on its terminal 112. The receiver device 112 thereupon creates, in a step 133, a (second) sharing identifier 134 (and in this case preferably uses the same calculation scheme as for the first sharing identifier 128). The terminal 112 can request an account ID for the user 114 from its backend 116, if it is not present in any case on the receiver device 112, and vehicle-related data can be taken from the received sharing URL (or requested by means of the URL from infrastructure for key sharing).

The second sharing identifier 134 can be incorporated, for example, in an endpoint certificate for the granted key 120 as an expansion. In a step 136, the key sharing procedure is continued; this can comprise in particular that the second sharing identifier 134, for example, by means of the mentioned endpoint certificate, reaches the vehicle-side backend server 104.

In a step 138, the backend server 104 verifies the key sharing procedure or carries out a receiver-related verification. In this case, the first sharing identifier 128 received in prior step 130 (i.e. the stored hash value which identifies the intended receiver 114 in anonymized form) is compared with the second sharing identifier 134, i.e. the hash value, which was calculated using the same calculation method in the receiver device 112, specifically prompted by the reception of the sharing URL in the running key sharing procedure 122.

If the verification 138 should fail, this can mean that the sharing identifiers were formed based on different usernames, i.e. the actual receiver of the shared key (at this time not yet activated) is not the intended receiver 114. Therefore, the further key sharing procedure would be aborted and activation of the shared key on the receiver device would not take place. If the verification should have the result, however, that the receiver is the intended receiver 114, i.e. the sharing URL was retrieved on the intended receiver device 112, the further key sharing procedure can run, which ends with the shared vehicle key 120 being activated in the receiver device 114 and announced to the vehicle 102 in a step 140.

The key sharing 122 is described above which is triggered by the sharing user 108 at the receiver device 106 in steps 124 (inputting the receiver) and 126 (requesting an anonymized hash value). Instead, key sharing in server-based key sharing (SBxD) can also be initiated by a server (in FIG. 1: the server 110; initiating comparable to step 124 is indicated by the dashed arrow 142), for example in reaction to a booking procedure performed by the receiver 114. The server 110 can in particular be a part of the backend 104, and can be operated by a producer of the vehicle 102, or by a service provider for car sharing or another service, a provider for key management, etc. In such a constellation, a step 144 comparable to step 130, to store the obtained first sharing identifier, can be implemented particularly easily and securely if the requesting device 110 and the vehicle-side server 104 are part of the same backend system.

Secured key sharing according to the invention, as shown by way of example in FIG. 1, can be carried out independently of a second factor and does not require a second factor. However, a 2FA or MFA method can also be provided for key sharing to maintain the highest security standards, meet expectations of customers, etc.

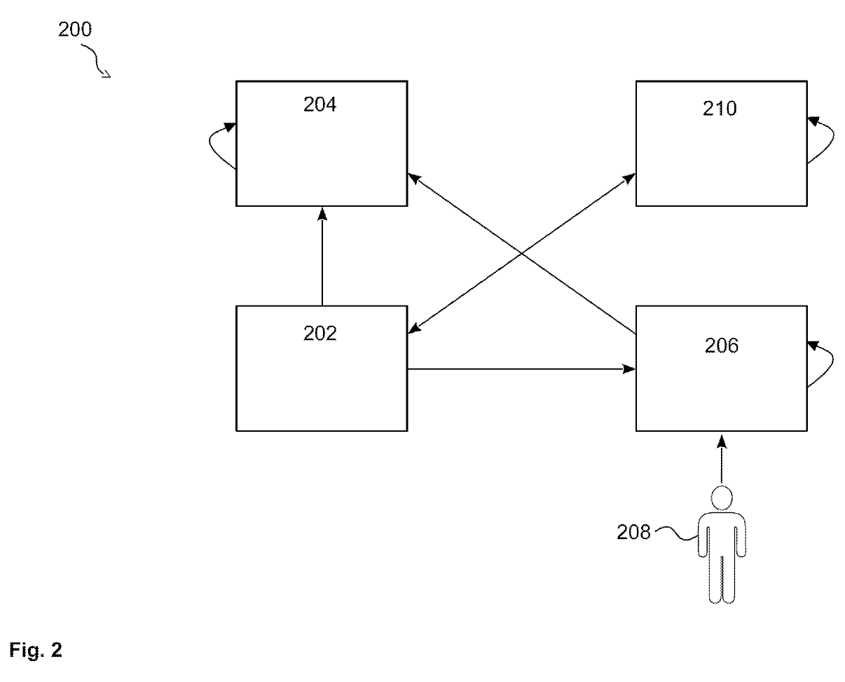

FIG. 2 shows, in the form of a schematic block diagram, a further exemplary embodiment of a system 200 having a key-sharing point 202, a server 204 in a (for example, producer-side) backend for a vehicle (not shown), a terminal or receiver device 206 of a user or receiver 208, and a server 210 in a (for example, producer-side) backend for the receiver device 206.

The components of the system 200 shown in FIG. 2 interact in order to achieve secured key sharing according to the invention from the key-sharing point 202 on the terminal 206, for example, if the key-sharing point 202 implemented as a terminal and the terminal 206 are assigned to different user accounts, or if the key-sharing point 202 implements server-based key sharing.

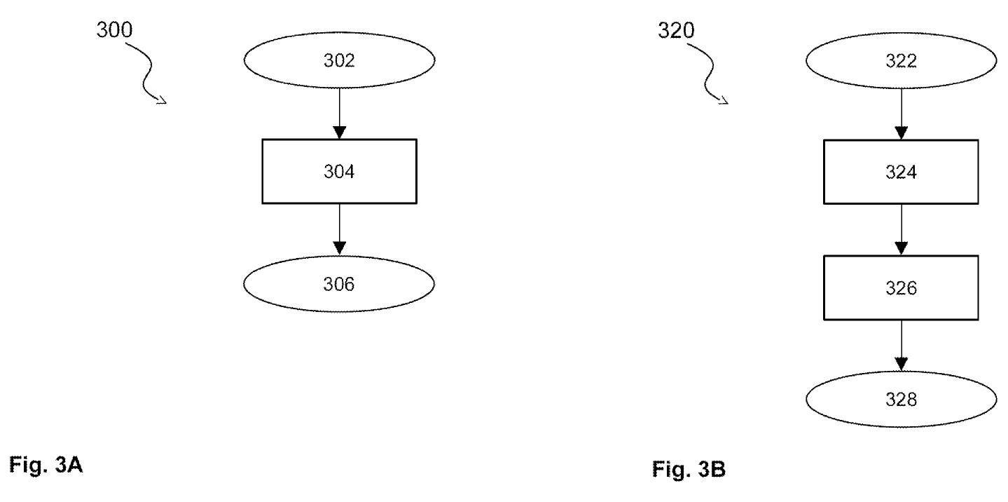

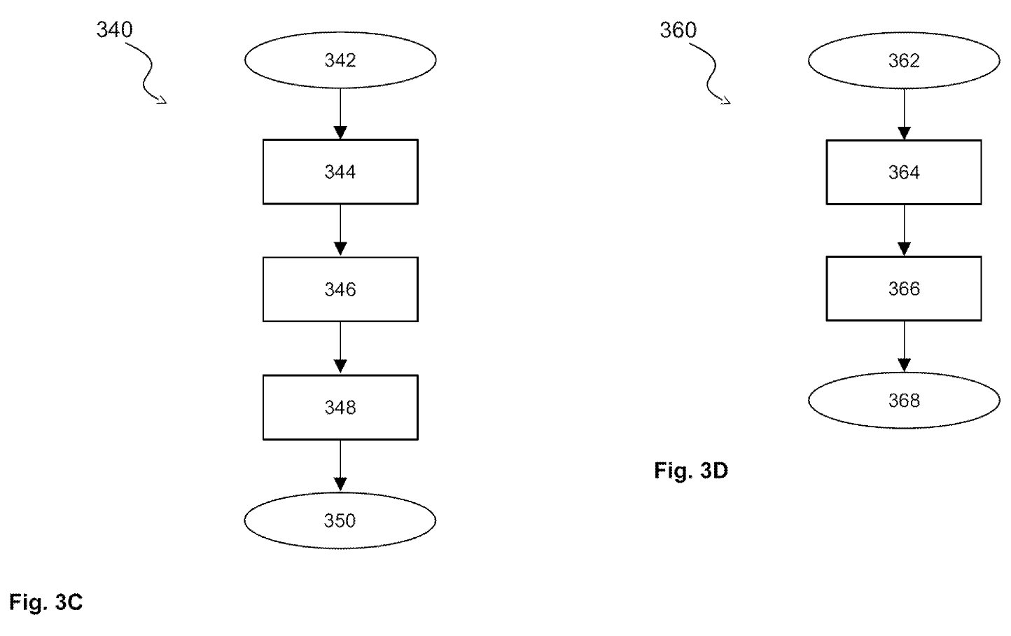

A specific sequence for corresponding key sharing in the system 200 will be described in more detail hereinafter with reference to the sequences schematically shown in FIGS. 3A, 3B, 3C, and 3D. In this case, FIG. 3A shows a sequence of a method 300 for sharing a digital key for a motor vehicle in the key-sharing point 202. FIG. 3B shows a sequence of a corresponding method 320 in the server 204. FIG. 3C shows a sequence of a corresponding method 340 in the server 208. FIG. 3D shows a sequence of a corresponding method 360 in the receiver device 206.

A sequence can begin in the method 300 in FIG. 3A in a step 302 in that the key-sharing point 202 receives a specification, which in the further course of the sequence permits an identification of a user account of the user 208. If the key-sharing point 202 comprises a terminal, the specification can be an email address, a telephone number, an account name (for example, a username), etc. If the key-sharing point 202 comprises a server, for example, a customer server, booking server, etc., the specification can additionally or alternatively relate to a customer, a customer account, etc. and it can be necessary to resolve a customer ID, customer number, etc. into a username of the user 208 with respect to a user account on the backend server 210; for example, the server 202 could hold corresponding registration data which permit a corresponding resolution.

In a step 304, the key-sharing point 202 provides, based on the received specification, a first sharing identifier, thus, for example, a hash value, in which an account ID of an account of the user 208 is processed at a producer of the device 206 and operator of the server 210 in anonymized form, and possibly further specifications, such as information (a datum or multiple data) on the motor vehicle, thus, for example, a vehicle ID, VIN (“Vehicle Identification Number”), information or an identification with respect to a producer of the vehicle, etc.

The provision in step 304 can comprise sending the specification relating to the intended receiver 208 to the backend 210 of the receiver device 206, so that there the specification on the receiver 208 is resolved into an account ID or the like and the (preferably anonymized) first sharing identifier is created therefrom. The sending of the specification can run via a server in a backend for the key-sharing point 202 if the point 202 is a terminal. The sending of the specification could take place directly to the server 210 if, for example, the terminals originate from the same producer, or if the key-sharing point 202 is a server.

In a corresponding step 322 in method 320 in FIG. 3B, the server 210, which can be operated by a producer of the receiver device 206, receives the specification relating to the receiver 208 from the key-sharing point 202. In a step 324, the server 210 determines, based on the received specification, an account assigned to the receiver 208, thus, for example, a user account or in general an account assigned to the person of the user 208.

In a step 326, the server 210 calculates, based on the determined account, the above-mentioned first sharing identifier. Provided that in step 322, in assignment to the specification, information relating to the motor vehicle was received, the calculation in step 326 comprises processing this vehicle-related information in the calculation of the first sharing identifier.

In a step 328, the server 210 returns the calculated first sharing identifier to the key-sharing point 202. The sequence specific to the invention is thus ended in the server 210, regardless of whether a sequence of a further key sharing known per se incorporates the server 210.

In a step 306 (method 300 in FIG. 3A), the key-sharing point 202 sends the first sharing identifier to the server 204 in the vehicle-side backend for a verification of the key sharing. The sequence specific to the invention is thus ended in the key-sharing point 202, regardless of whether a further sequence of a key sharing known per se incorporates the key-sharing point 202.

In a corresponding step 342 (method 340 in FIG. 3C), the server 204 receives the first sharing identifier and stores it beforehand (i.e. before a further sequence of the key sharing) in assignment to the digital key which is affected by the key sharing, or a user account of an owner of the key (“owner”, also “friend”), wherein in this case it can be a person or a server-based service. In one exemplary embodiment, an identification relating to the backend 210 for the receiver device 206 is received together with the first sharing identifier and likewise stored for verification purposes in assignment to the digital key or an account of the sharing user.

In the further course of the key sharing, information relating to key sharing arrives at the receiver device 206 in a step 362 in method 360 in FIG. 3D. The information can be, for example, motor vehicle-related information. For example, this information can be contained in the scope of the key sharing in a sharing URL or obtained or retrieved from a relay server by means of the URL. Based on the obtained information, the receiver device 206 calculates a (second) sharing identifier in a step 364. The calculation can also incorporate a user identifier of the user 208 or be based thereon.

In a step 366, the receiver device 206 generates a certificate relating to the granted digital key, for example, in the context of a key sharing procedure known per se (for example, creating an endpoint on the receiver device 206). In this case, the certificate can contain the second sharing identifier as an expansion or the like. In a step 368, the created certificate reaches the server 204, for example, in the context of key sharing known per se. The sequence specific to the invention is thus ended in the receiver device 206, regardless of whether a sequence known per se of key sharing further incorporates the receiver device 206.

In a corresponding step 344 (method 340 in FIG. 3C), the certificate having the second sharing identifier is received in the vehicle-side backend 204. In a step 346, the producer server 204 verifies the key sharing. More precisely, it is checked whether the key sharing procedure runs as intended, i.e. whether the granted key is deposited on the receiver device 206, which is assigned to a user account of the intended user 280 in the producer backend 210 of the receiver device 206. The verification takes place based on the first sharing identifier previously stored in step 342 and the second sharing identifier obtained in step 344, and comprises in particular comparing the two identifiers. If they are hash values, they can be checked for a presence of identity.

In a step 348, which can take place before, parallel to, or after step 346, verification takes place based on the stored indication of the producer of the receiver device 206. The verification takes place based on the producer indication stored in step 342 together with the first sharing identifier and a producer indication taken from the certificate obtained in step 344 or obtained in another way by the key sharing procedure under discussion. The verification in particular comprises comparing the two producer indications.

The method ends in a step 350, in that (after positive verification in steps 346 and 348) further key sharing runs, key tracking takes place, etc.

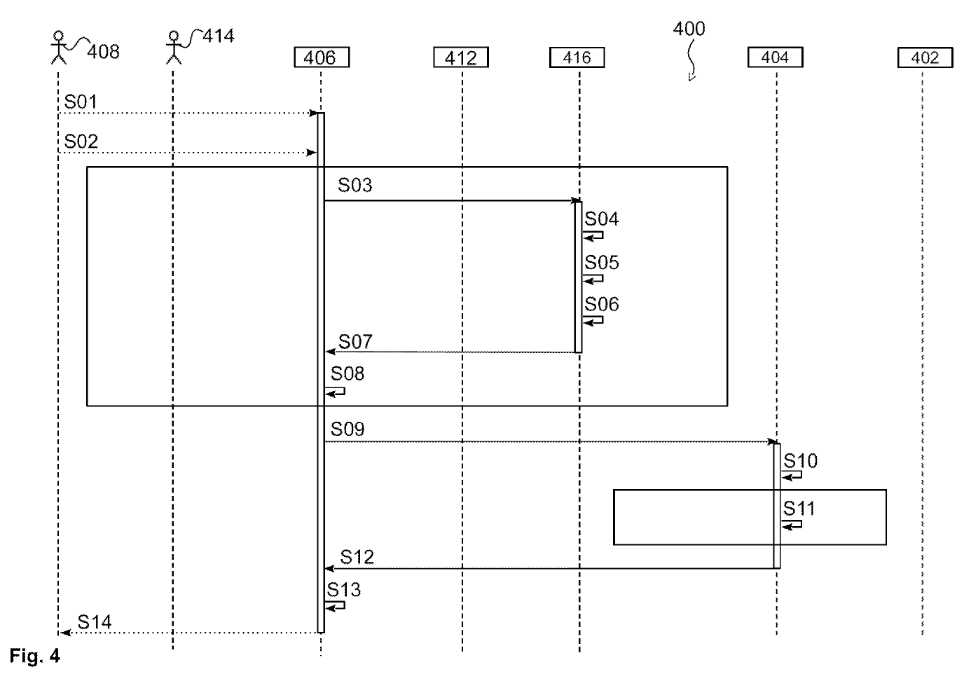

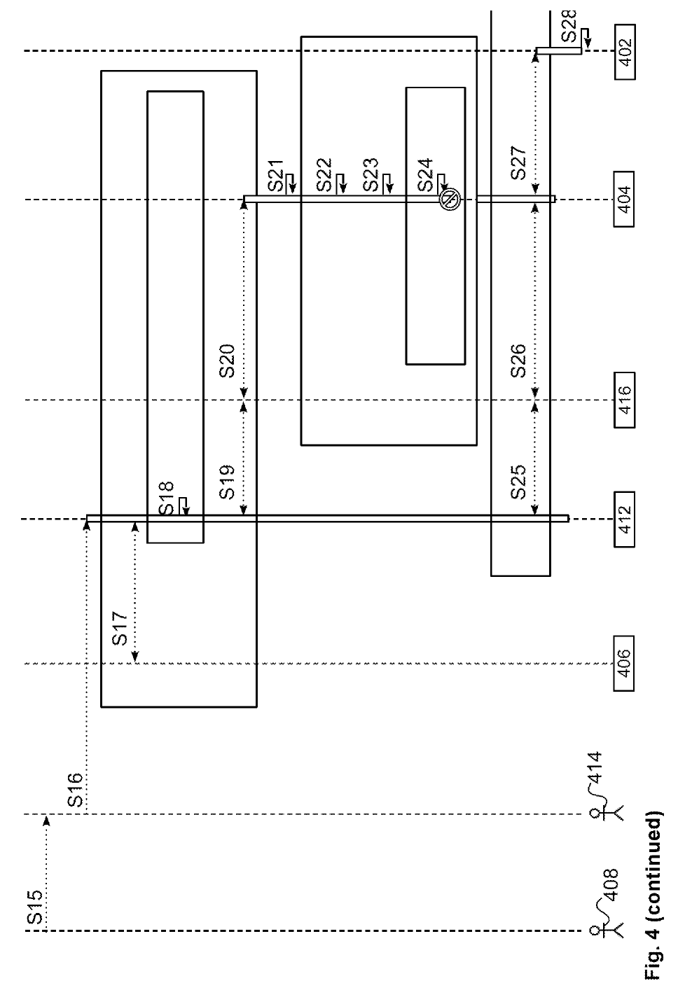

FIG. 4 illustrates, in the form of a schematic sequence diagram, a further exemplary embodiment of a method 400 for sharing a digital key for a motor vehicle 402, wherein a server 404 in a backend for the vehicle 402, a sharing terminal 406 of a user 408, a receiving terminal 412 of a receiver or user 414, and a server 416 in a backend for the receiver device 412 interact.

The method 400 implements secure key sharing between the users 408 and 414 (different user accounts) by means of the account information hash (“AccountInfoHash”) standardized by the CCC, wherein the key sharing is also based on a device producer of the receiver device 112.

For this purpose, the sharing user 408 names the receiver 414 of the digital key to be shared beforehand (i.e. before the beginning of the actual key sharing). More precisely, the user 408 specifies an essential property of the receiver 414 or a, for example, account or username of the user 414 for their account with a producer of the receiver device 412, i.e. on the server 416. The username (or a specification, ID, etc. derived therefrom) is used together with an indication of a producer of the vehicle 402 and a vehicle ID to calculate the account information hash according to CCC.

The account information hash can be viewed here as an (anonymized) identifier or ID of the relevant user or user account. Preferably, only this anonymized identifier or sharing identifier is accessible to the vehicle producer or operator of the backend 404.

The account information hash is used to define the key sharing on the specified or intended user account of the user 414 or restrict it such that the use of the shared key is not possible on a terminal which is not assigned to the specified user account of the user 414.

In detail, the user 408 initiates, in a step S01, a key sharing procedure by means of a corresponding control operation on the sharing device 406, for example in an app provided by a producer of the vehicle 402 for management of a digital key for the vehicle 402. In a step S02, the sharing device 406 receives the above-described specification or information from the user 408, which permits it to uniquely identify the receiver 414. This can be an email address, telephone number, an account name, username, etc. The specification is input or selected by the user 408 on the device 406, for example from a list of contacts, etc. In addition, the user 408 can make a specification on a producer of the receiver device 412; for example, the user can be prompted to select a producer from a list.

The following steps S03 to S08 relate to providing or compiling information in order to restrict or define the key sharing in the above-described manner to a receiver device (in the example: the receiver device 412) of the intended receiver or user 414. In step S03, the sharing device 406 sends a request for an account information hash to the backend server 416 of the receiver device 412. The request transfers, for example, the input or specified username for the user 414, an identification of a vehicle producer, and a vehicle ID. The specifications or IDs on vehicle and vehicle producer can be taken, for example, from meta-information of the key to be shared (the key is deposited, for example, as an endpoint according to CCC on the sharing device 406). Concepts such as the vehicle ID (“vehicle identifier”) or also vehicle producer ID (“vehicle OEM ID”) are familiar to a person skilled in the art, for example, from a CCC environment.

The communication between sharing device 406 and server 416 (steps S03, S07) can either run directly, for example if the devices 406 and 412 originate from one and the same producer, or can run via a server in a separate backend for the device 406, for example if the devices 406 and 412 are from different producers. The communication can take place in an encrypted manner in order to protect the mentioned specifications or IDs from misuse.

In a step S04, the server 416 resolves the received username, i.e. determines a unique user ID or user account ID for the user 414, wherein the ID in the present example in particular relates to a user account to which the receiver device 412 is assigned. It is to be noted that the determined user ID or account ID can be specific for the backend 416. For example, the ID can be specific for a producer of the receiver device 412, and/or the ID is unique in the environment (i.e. the backend 416) provided or operated by the producer of the receiver device 412.

In step S05, the backend server 416 determines a salt for the vehicle producer from the transferred or received vehicle producer ID. Cryptographic “salting” is known to a person skilled in the art and a further description will therefore be omitted here.

In step S06, the server 416 calculates an account information hash. Such a hash is standardized according to CCC standard, and then relates to a cryptographic hash function (for example SHA-256) having the arguments account ID, vehicle ID, and the salt determined in step S05 for the vehicle producer.

In step S07, the backend server 416 returns the calculated account information hash to the sharing device 406. In step S08, the sharing terminal 406 compiles information for secure key sharing, wherein the information comprises a producer ID for a producer of the intended receiver device and the returned account information hash. The producer ID can either be determined from a selection made by the user 408 in step S02 or can be determined independently, for example, by a backend of the device 406, for example, from properties of the username or account name of the user 414.

In step S08, the compiled information can be encrypted and/or signed (for example “signedSharingSecInfo” according to CCC). In a step S09, the sharing device 406 sends a request for prior sharing or storing of data before actual key sharing (for example “preShare”-API according to CCC) to the vehicle-side backend server 404. The request contains a sender ID and the above-described signed information.

In a step S10, the backend server 404 decrypts the obtained information and verifies it. The obtained or sharing-relevant information is then stored such that an assignment is possible. More precisely, the backend server 404 stores the obtained information, wherein the account information hash relating to the receiver 414 and the producer ID relating to the producer of the receiver device 412 are optionally stored together with further data as assignment information in order to enable an assignment of the key sharing to the intended user account or the receiver 414 initially specified by the user 408 during the actual key sharing or key tracking.

In a step S12, the backend server 404 returns an indication relating to a successful performance of the prior storage to the sharing device 406. In a step S13, the sharing device 406 prepares the actual key sharing (a relay server (not shown) can also participate therein, for example), and in this context receives a sharing URL. In a step S14, the sharing user 408 copies the sharing URL, for example, in an email program, a chat program, etc. and in a step S15 sends the sharing URL to the receiver 414.

The receiver 414 retrieves, in a step S16, the sharing URL on the receiver device 412. Steps S17 to S20 relate to a first (partial, initial) key sharing procedure running thereupon. In particular, in a step S17, a key sharing procedure runs between sharing device 406 and receiver device 412. As a result of this, a step S18 in the receiver device 412 relates to storing assignment information (the term is used here as described further above) in an endpoint certificate. In detail, the receiver device 412 creates an endpoint in the running key sharing procedure and generate a digital key (the shared vehicle key for the vehicle 402, the details are routine to a person skilled in the art). Furthermore, the receiver device 412 outputs a certificate relating to the shared digital key. An account information hash is calculated in this case and stored as an expansion of the endpoint certificate. This procedure is preferred under security aspects. As a less secure variant, it would also be conceivable to only transfer the account information hash as a parameter during key tracking.

In steps S19 and S20, a key sharing method runs between receiver device 422 and backend server 416, and between backend server 416 and server 404 in the vehicle-side backend. In the course of this, the endpoint certificate created in step S18 in the receiver device 412 reaches the server 404. In a step S21, the backend server 404 verifies a chain of trust (“certificate chain”) of the certificate. This can be the case during key tracking (more precisely during a request for key tracking from the server 416 in the device backend to the server 404 in the vehicle backend).

In steps S22 and S23, a verification of the information previously stored in the backend server 404 in step S11 in relation to the information transmitted on the receiver side in the key tracking request in step (S19 and) S20. It is presumed in this case that the verification takes place in relation to the account information hash as is present as an expansion in the endpoint certificate and was transmitted (alternatively as a parameter in the key tracking).

In step S22, the server 404 verifies that or whether the producer ID according to the previously stored information corresponds to the device producer 416 of the receiver device 412. In step S23, the server 404 verifies that or whether the account information hash according to the previously stored information corresponds to the hash as received from the receiver device 412 (or backend 416). If it should prove in at least one of steps S22 and S23 that there is no correspondence, then this means that the receiver device according to the initiated key sharing is not a device of the user 414 intended by the receiver 408 (and/or is not an intended terminal). The vehicle-side backend server 404 would thereupon abort the key sharing, i.e. the processing of the request for key sharing sent by the sharing user 408 in step S01 is ended.

However, if the verification in steps S22 and S23 runs positively, the key sharing procedure is finalized in steps S25, S26, and S27. In this case, a key tracking receipt from the backend 404 reaches the receiver device 412. The receiver device 412 incorporates the receipt in attestation data and stores them in a private mailbox of the granted digital key. The backend server 404 accordingly incorporates the receipt in the received attestation data and sends the attestation to the vehicle 402. In a step S28, the shared digital key is persisted in the vehicle 402.

Embodiments of the invention can ensure that a key derived or shared from a digital key, in particular vehicle key, is only activated, or can be used, for example for access to a vehicle, if the key is deposited on an intended terminal, more precisely on a terminal which is assigned to an intended receiver or user (even more precisely, a terminal which is assigned to a user account of the intended user). The intended receiver is previously specified by the sharing user. An attempt to have the shared key arrive at a user other than the intended receiver (for example, in that a sharing URL is forwarded to a terminal of the other user) results in an abort of the key sharing procedure.

Embodiments of the invention can thus prevent misuse based on forwarding a URL for the key sharing, for example, from an intended terminal without knowledge or authorization of the sharing user to another device. The invention can therefore contribute to increasing the general trust in the practicality and security of digital vehicle keys.

Embodiments of the invention do not have to, but can be easily combined with further security features and in this way permit a flexible adaptation to predetermined security standards, corresponding expectations of the users, etc. Additional security can be provided, for example, by a prior definition of a specific producer of the receiving device (and the corresponding check), or be provided by a second factor (2FA or MFA). Such embedding options are also performed to increase the general trust in the use and security of digital keys, as this is of great importance with regard to the increasing propagation of digital vehicle keys.

However, embodiments of the invention also permit, vice versa, in specific applications in which this is less practical, for example in the repair shop sector, to dispense with additional security mechanisms such as authentication by means of input of a password, a PIN, etc. Therefore, concepts according to the invention for digital vehicle keys, key sharing, etc. can be adapted flexibly to the greatly varying applications.

Some embodiments of the invention comprise the reuse of an account information hash which is known per se, for example standardized. This enables comparatively simple, rapid, cost-effective, and less error-prone implementations of the invention.

Embodiments of the invention allow data protection requirements to also be considered efficiently in that, for example, information relating to a receiver of the key to be shared only reaches a vehicle backend in anonymized form.

Embodiments of the invention are of commercial interest for vehicle producers, device producers, car sharing providers, third-party providers of services such as breakdown service, parking service, etc. and all corresponding tier 1 suppliers with respect to digital keys, in particular vehicle keys.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### Reference signs

100 system

102 motor vehicle

104 backend for the vehicle (producer)

106 terminal (key-sharing point)

108 user

110 server (key-sharing point)

112 receiver device

114 receiver

116 backend for the receiver device (producer)

118 digital key for the vehicle

120 derived or shared key

122 key sharing procedure

124 input

126 request sharing identifier

128 first sharing identifier

130 prior information to the vehicle backend

132 retrieve URL

133 create sharing identifier

134 second sharing identifier

136 further key sharing procedure

138 verification

140 key at motor vehicle

142 initiating key sharing

144 prior information to the vehicle backend

200 system

202 key-sharing point

204 server

206 receiver device

208 user

210 server

300 method in a key-sharing point

302-306 steps of the method

320 method in a receiver backend

320-328 steps of the method

340 method in the vehicle backend

342-350 steps of the method

360 method in the receiver device

362-368 steps of the method

400 method

402 vehicle

404 backend server for the vehicle

406 sharing terminal

408 user

412 receiver device

414 receiver

416 backend server for the receiver device

S01-S08 providing first account information hash

S09-S12 previously storing first account information hash

S13-S20 key sharing, calculating second account information hash

S21-S24 verifying

S25-S28 further key sharing

What is claimed is:

1. A method for sharing a digital key for a motor vehicle, comprising:
receiving a specification relating to a receiver of the digital key;
based on the received specification, providing a first sharing identifier; and
sending the first sharing identifier to a vehicle-side backend for verification of the sharing of the digital key.

2. The method of claim 1, wherein the providing comprises sending the specification to a backend of a receiver device.

3. A method for sharing a digital key for a motor vehicle, comprising:
receiving a specification relating to a receiver of the digital key from a key-sharing point;
based on the received specification, determining an account assigned to the receiver;
based on the determined account, calculating a first sharing identifier; and
sending the first sharing identifier to the key-sharing point.

4. The method of claim 3, wherein, in assignment to the specification, information relating to the motor vehicle is received, and wherein the calculation of the first sharing identifier comprises processing the information.

5. The method of claim 3, wherein the key-sharing point comprises one of: a terminal and a server.

6. The method of claim 3, wherein the specification comprises at least one of an email address, a telephone number, an account name.

7. A method for sharing a digital key for a motor vehicle, comprising:
receiving information relating to the motor vehicle;
based on the information, calculating a second sharing identifier; and
generating a certificate relating to the digital key, wherein the certificate contains the second sharing identifier.

8. A method for sharing a digital key for a motor vehicle, comprising:
storing a first sharing identifier in assignment to the digital key; and
verifying the key sharing based on the stored first sharing identifier.

9. The method of claim 8, wherein the key sharing comprises receiving a second sharing identifier, and wherein the verifying comprises comparing the stored first sharing identifier and the received second sharing identifier.

10. The method of claim 8, further comprising:
storing an indication relating to a backend for a receiver device of the key sharing, wherein the verification takes place based on the stored indication.

11. The method of claim 9, wherein the first and/or the second sharing identifier is or are anonymized.

12. The method of claim 9, wherein the first and/or the second sharing identifier comprises a standardized hash value.

13. A terminal configured to carry out the method of claim 1.

14. A backend server configured to carry out the method of claim 3.

15. A system for sharing a digital key for a motor vehicle, comprising:
the motor vehicle;
a key-sharing point configured to:
receive a specification relating to a receiver of the digital key;
based on the received specification, provide a first sharing identifier; and
send the first sharing identifier to a vehicle-side backend server for verification of the sharing of the digital key;
a receiver device configured to:
receive information relating to the motor vehicle;
based on the information, calculate a second sharing identifier; and
generate a certificate relating to the digital key, wherein the certificate contains the second sharing identifier;
